(19) United States
(12) Patent Application Publication
(10) Pub. No.: US 2023/0133451 A1
(43) Pub. Date: May 4, 2023

(54) VEHICLE WASH FACILITY

(71) Applicant: Squeaky Shine LLC, Novi, MI (US)

(72) Inventors: Ryan Michael Belanger, Novi, MI (US); Gregory Andrew Richard, South Lyon, MI (US)

(21) Appl. No.: 17/979,956

(22) Filed: Nov. 3, 2022

Related U.S. Application Data
(60) Provisional application No. 63/274,980, filed on Nov. 3, 2021.

(51) Int. Cl. B60S 3/00; E04C 2/54

(52) U.S. Cl. CPC B60S 3/004; E04C 2/54; B60S 3/002

(57) ABSTRACT

A vehicle wash facility includes a bay extending between a pair of sidewalls and including at least one cleaning component. An upper level structure is located above the bay and supports a supporting component associated with the cleaning component above the at least one cleaning component. The upper level structure may be configured as a mezzanine structure that hangs from a ceiling of the car wash facility and is in the form of a grate. The upper level structure is stacked above the cleaning area, reducing the overall footprint and providing visibility through the sidewalls to the cleaning area. The upper level structure may be spaced form the sidewalls to define an open space in which cleaning components can move vertically. The cleaning components may be accessible through the upper level structure.

### CROSS-REFERENCE TO RELATED APPLICATIONS

This application claims the benefit of U.S. Provisional Patent Application No. 63/274,980, filed Nov. 3, 2021, the entire content of which is hereby incorporated by reference in its entirety.

### BACKGROUND OF THE INVENTION

### 1. Field of the Invention

The present disclosure relates generally to a vehicle wash facility that includes components for cleaning an exterior surface of a vehicle. More specifically, the present disclosure relates to a vehicle wash facility having an upper level structure for supporting various cleaning and drying components.

### 2. Description of the Prior Art

Commercial vehicle wash systems have been developed to clean and dry passenger vehicles quickly and efficiently. These vehicle wash systems have been developed to include a number of cleaning components that are located and oriented to clean different sections of the vehicle exterior. For example, vehicle wash systems often include spray nozzles that initially coat the vehicle in fluids (e.g., chemicals, soap, and water) and a series of brushes that scrub and clean different surfaces of the vehicle exterior. After the vehicle has been cleaned and rinsed, it is beneficial to dry the vehicle to avoid water streaks and unwanted attraction of dirt and other debris. As such, these vehicle wash systems have also been developed to include a number of drying components that are located and oriented to dry different sections of the vehicle exterior. These drying components may include a combination of drying brushes and blowers. In operation, movement of the various cleaning and drying components may be electrically, mechanically, hydraulically, or pneumatically driven. Often times, the operable configurations and movements of the various cleaning and drying components become difficult based on packaging limitations, complicated fluid line circuits, fluid reservoirs, electronic circuitry, and other features that have traditionally been required to be located within a bay of the facility. For example, fluid lines often times extend several meters between a reservoir and a spray nozzle. As such, operation of the spray nozzle can be delayed and fluid within the fluid line can be wasted.

Accordingly, there is a continuing desire to further develop vehicle wash facilities to include structures for improved packaging of cleaning and drying components.

### SUMMARY OF THE DISCLOSURE

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims. This section provides a general summary of the disclosure and is not to be interpreted as a complete and comprehensive listing of all of the objects, aspects, features and advantages associated with the present disclosure.

It is therefore an aspect of the disclosure to provide a vehicle wash facility having an upper level structure for supporting various cleaning and drying components.

It is another aspect of the disclosure to provide a vehicle wash facility having an upper level structure for supporting various fluid reservoirs directly above associated cleaning and drying components.

It is another aspect of the disclosure to provide a vehicle wash facility having an upper level structure for supporting various fluid line circuits, fluid reservoirs, and electronic circuitry above associated cleaning and drying components.

It is another aspect of the disclosure to provide a vehicle wash facility that provides a bay having sidewalls extending along a length that are substantially transparent.

In another aspect of the disclosure, a vehicle wash facility is provided. The vehicle wash facility comprises a bay extending between a pair of sidewalls and including at least one cleaning component. An upper level structure is located above the bay and supports at least one of a fluid line, electrical line, or air line above the at least one cleaning component. The upper level structure hangs from a ceiling of the car wash facility and is in the form of a grate.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 illustrates a perspective view of a vehicle wash facility including a bay with an upper level structure supporting a variety of cleaning and drying components;

FIG. 2 illustrates a schematic top view of a frame structure of the vehicle wash facility;

FIG. 3 illustrates a schematic top view of the upper level structure extending across the bay;

FIG. 4 illustrates a schematic top view of various components located within the bay and below the upper level structure;

FIG. 5 illustrates a schematic top view of various components supported on or above the upper level structure;

FIGS. 6A through 6D illustrate connections between various components and the upper level structure to the frame structure;

FIG. 7 illustrates a cross-sectional, side view of the car wash facility;

FIG. 8A illustrates a first end of the bay and FIG. 8B illustrates a second end of the bay;

FIGS. 9A and 9B illustrate side views of the bay showing a series of connectors for associated cleaning components and drying components supported on or above the upper level structure;

FIG. 10A illustrates a first end of the bay and FIG. 10B illustrates a second end of the bay showing various components supported on or above the upper level structure;

FIG. 11 illustrates additional connectors for associated cleaning components and drying components supported on or above the upper level structure;

FIGS. 12A and 12B illustrate fluid inputs and outputs extending above and below the upper level structure; and

FIG. 13 illustrates additional fluid inputs and outputs extending above and below the upper level structure.

### DETAILED DESCRIPTION OF THE DISCLOSURE

Example embodiments will now be described more fully with reference to the accompanying drawings. In general, the subject embodiments are directed to a vehicle wash assembly including an upper level structure for supporting various cleaning and drying components. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Referring to the Figures, wherein like numerals indicate corresponding parts throughout the several views, a vehicle wash assembly is illustrated. The vehicle wash facility includes an upper level structure for supporting various cleaning and drying components. The vehicle wash facility improves upon the operational framework, packaging, and efficiency of traditional cleaning bay systems that have been used to clean and dry a vehicle body.

The present disclosure relates to a vehicle wash facility, the vehicle wash facility includes a vehicle wash system, which may be configured as a rollover type system where the vehicle remains stationary and the various treatment components may be moved with respect to the vehicle, a conveyor type system where the vehicle is moved with respect to the vehicle wash system, or a combination thereof. As is known to one of ordinary skill in the art, a vehicle wash facility utilizes various components that treat a vehicle in a predetermined sequence to both clean and dry the vehicle. It will be appreciated that the various aspects, components, or portions of the disclosed vehicle wash facility may be employed in connection with a variety of other applications outside of a rollover or conveyor vehicle wash system, such as a manual wash or self-service wash process.

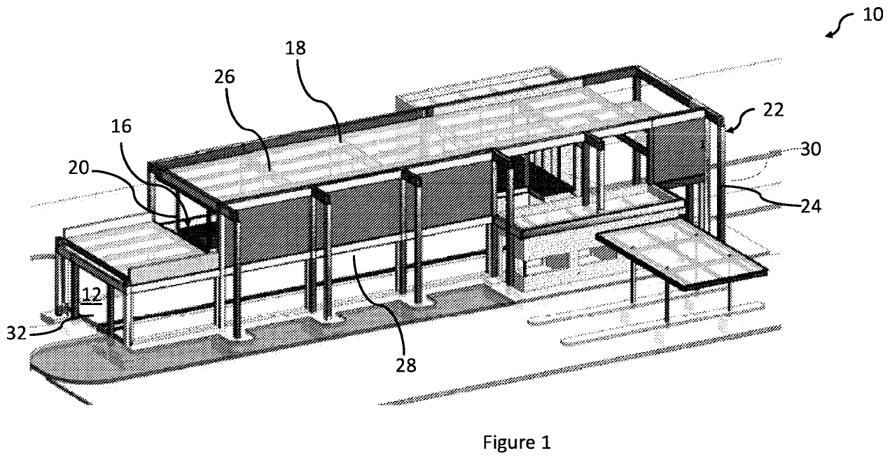

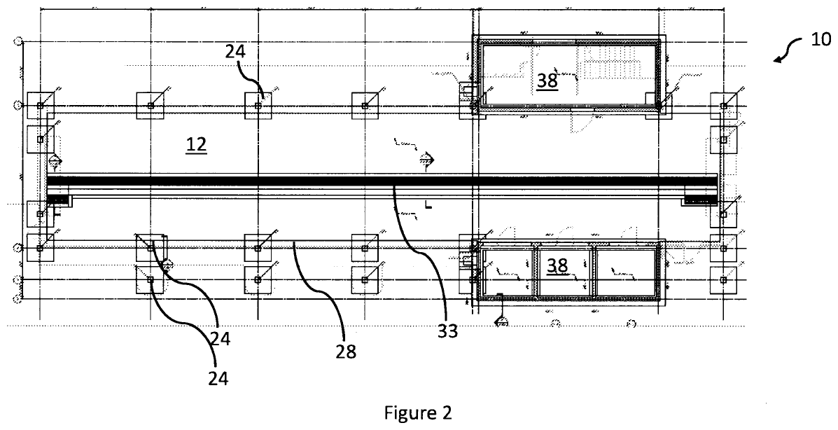

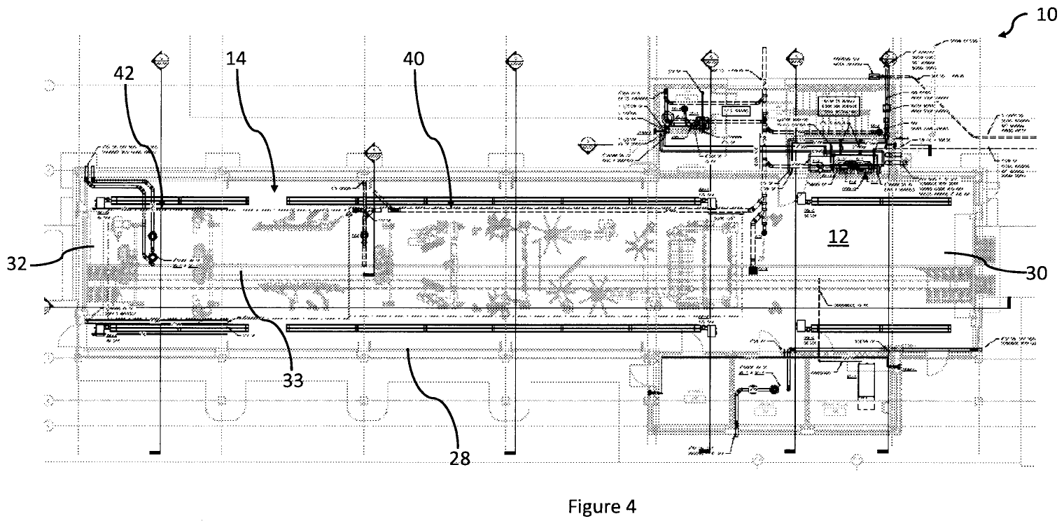

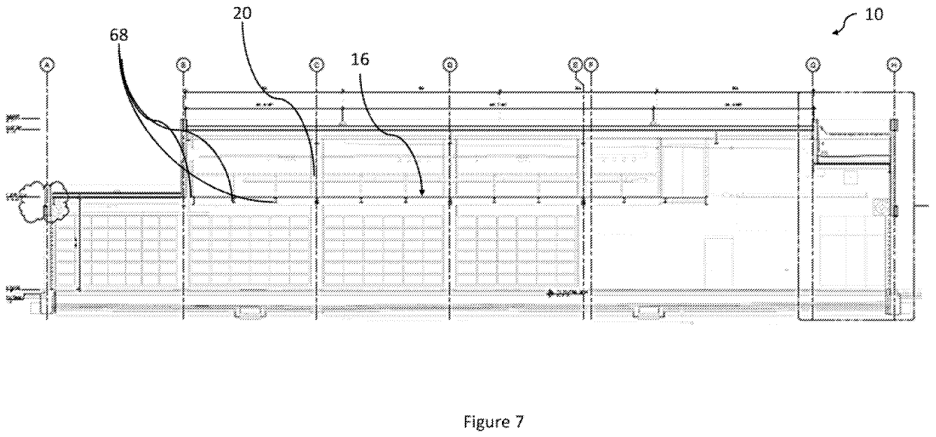

With initial reference to FIG. 1, the vehicle wash facility 10 is shown. The vehicle wash facility 10 may include a bay 12 having a vehicle wash system 14 (FIG. 4). An upper level structure 16 may be located above a vehicle cleaning area (the lower portion of the bay 12) in an upper portion of the bay 12. The vehicle cleaning area is the area through which the vehicle passes. In some embodiments, the upper level structure 16 may be configured as a mezzanine structure that is supported by a ceiling 18 of the vehicle wash facility 10 and “hangs” via a series of cables or hanging pillars 20 that are supported by the ceiling 18 and extend downward. More particularly, the vehicle wash facility 10 may including a frame structure 22 that includes a plurality of vertical columns 24 and horizontal beams 26 and the upper level structure 16 may be configured as a mezzanine structure that hangs from one or more of the horizontal beams 26 via hanging pillars 20. In some embodiments, the upper level structure 16 may be configured as a second floor with conventional frame supports (e.g., joists and girders, which may be formed of metal). The upper level structure 16 may be supported by the floor with pillars or similar structure extending upward from the floor. In one aspect, some portions of the upper level structure 16 may be supported by the floor, with other portions of the upper level structure supported by the ceiling. In another aspect, at least some of the upper level structure 16 may be supported by the walls (including the sidewalls). In some embodiments, at least some of the horizontal beams 26 are configured as I-beams. The bay 12 may include a pair of longitudinal sidewalls 28 that extend between an entry 30 and an exit 32. The sidewalls 28 may include, at least in part, transparent or translucent walls, such as via glass sections that permit at least partial visibility into the bay 12. In some embodiments, the vehicle wash system 14 is a conveyor-type system and includes a conveyor assembly 33 (FIG. 2) that extends between the entry 30 of the bay 12 and the exit 32 of the bay 12. In use, the conveyor assembly 33 moves a vehicle from the entry 30 to the exit 32 and between components and component stations of the vehicle wash system 14. It will be appreciated that the overall structure of the facility shown in FIG. 1 may include walls, windows, or other enclosures. For example at the lower level, the sidewalls 28 could alternatively include roll-up doors in some sections (such as shown in FIG. 7), which roll-up doors could be formed from transparent or translucent sections or opaque sections. Above the exit 32 at the upper level, the wall recessed from the exit 32 may be an opaque wall (similar to the sidewalls show along the upper level) configured to support signage or the like. Similarly, the wall above the entry 30, which is shown generally flush/aligned from the entry, may also be opaque and configured to support signage above the entry 30. It will be appreciated that the upper wall at the exit 32 could be aligned/flush with the exit 32 and/or the upper wall at the entry could be recessed from the entry 30.

In some embodiments, the ceiling 18 is supported by one or more spaced apart vertical columns 24 and the sidewalls 28 are substantially transparent. For example, the sidewalls 28 may be formed of windows spaced by vertical columns 24 (as shown along the lower level in FIG. 1) and the windows may cover greater than 70%, 80%, or 90% of the sidewalls 28 or less. In some embodiments, the vertical columns 24 are provided in pairs on opposite sides the bay 12. FIG. 2 illustrates a schematic top view of the vehicle wash facility 10 illustrating various locations of the vertical columns 24. In the case of pairs of columns 24, the inner columns 24 of the pair may be used to define the corresponding sidewall 28, with the outer columns being spaced away from the sidewall 28. It will be appreciated that the pairs of columns illustrated in FIG. 2 could also be single columns, with the outer columns removed.

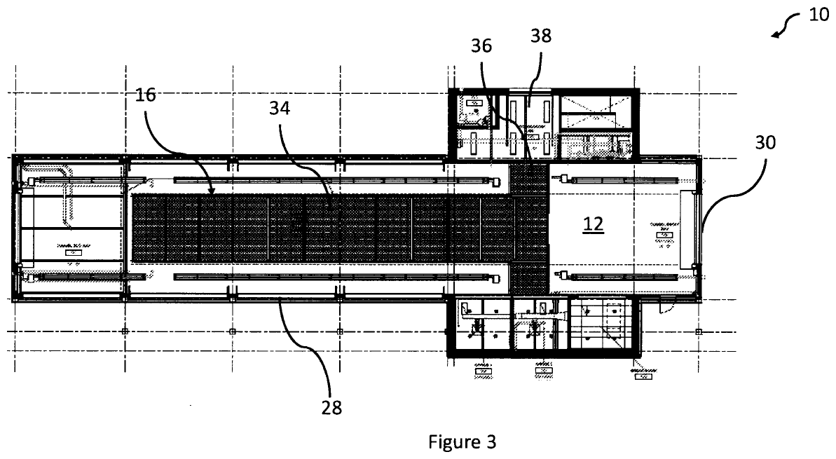

With reference now to FIG. 3, a schematic top view of the upper level structure 16 extending across the bay 12 is illustrated, in this case with the ceiling remove for clarity. The upper level structure 16 may include a longitudinal section 34 that extends at least partially along a length of the bay 12 between the entry 30 and the exit 32. The longitudinal section 34 may include a width extending between and spaced from one or both sidewalls 28 along at least a portion of the length. The spacing between the longitudinal section 34 and the sidewalls 28 may provide locations for cleaning components, drying components, or the like. The upper level structure 16 may further include a lateral section 36 that includes a width larger than that of the longitudinal section 34. In some embodiments, the lateral section 36 extends between doors on sidewalls 28 for providing access to a pair of control and/or service rooms 38 located on opposite sides of the bay 12. The control and/or service rooms 38 may include controllers, processors, and the like for dictating various functionalities of the cleaning components and drying components. The control and/or service rooms 38 may include fluid (e.g., water) input and output from the vehicle wash facility 10. The control and/or service rooms 38 may include additional features, such as user interfaces, power panels, fluid levels, pressure controls, and/or the like. In some embodiments, the upper level structure 16 may be configured in a grid pattern (e.g., of grate-formed material) such that fluid is not accumulated thereon and airflow is improved above the upper level structure 16. The grid pattern may also permit fluid lines and power lines to extend through openings of the grid pattern (e.g., a fiberglass grid). In some embodiments, the upper level structure 16 may be formed of a transparent or translucent material (e.g., Plexiglas). In some embodiments, the upper level structure 16 may formed of a combination of grate material and translucent material, wherein the grate material is located above one or more cleaning and drying components. In some embodiments, the grate material (or translucent material) may be configured in panels to open and close (e.g., be completely removed, open on a hinge or the like, etc.) to provide further access and serviceability to the one or more cleaning and drying components. In some embodiments, lights that provide visual stimuli are including on an upper surface of the translucent material and shine therethrough. FIG. 3 illustrates the upper level structure as a plurality of interlocked hinged grate-like structures, and it will be appreciated that such illustration is also representative of hinged or fixed translucent panels or the like, and that other sizes or arrangements of the panels are possible to suit the layout of associate vehicle was components located throughout the was facility.

FIG. 4 illustrates a schematic top view of various components located within the bay 12 and below the upper level structure 16, with the upper level structure 16 removed for clarity. These various components may hang from a bottom surface of the upper level structure 16 or be supported from a floor of the bay 12. These various components may include a plurality of cleaning components 40 (e.g., wet brushes, water sprayers, soap sprayers, and/or the like) and a plurality of drying components 42 (e.g., drying brushes, blowers, and/or the like). In FIG. 4, the cleaning components 40 are arranged upstream of the drying components 42. In correspondence with FIG. 3, it is clear that one or more of the cleaning components 40 or drying components 42 may be located directly beneath the upper level structure 16. In the section adjacent the entry 30, there may be no upper level structure 16 (as shown in FIG. 3). Similarly, the upper level structure 16 may terminate ahead of the exit 32. As shown, not all components are necessarily located directly below the upper level structure 16, as in FIG. 4 for example where some of the drying components 42 are not covered by the upper level structure 16.

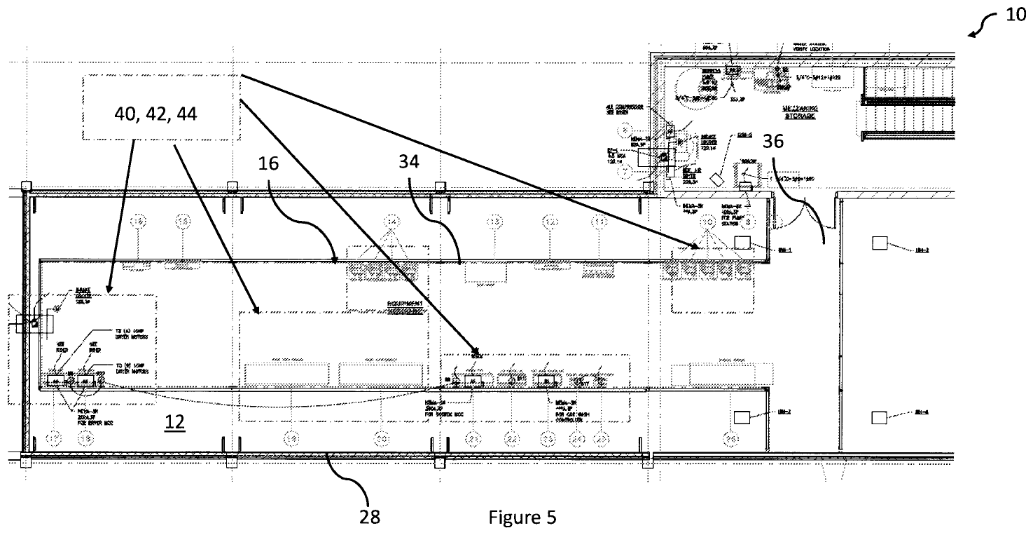

FIG. 5 illustrates a schematic top view of various components supported above the upper level structure 16. FIG. 5 is partially cut off relative to FIGS. 3 and 4, and does not illustrate the entry 30 or exit 32. These components, as shown in FIG. 5, may include supportive components 44 (e.g., electric wires, fluid lines, electric motors, fluid tanks, chemical tanks, soap tanks, fans, exhaust pipes, spare parts, generators, emergency lighting, and/or the like). However, the upper level structure 16 may also support a plurality of cleaning components 40 and/or a plurality of drying components 42. In some embodiments, the upper level structure 16 may include a supportive component 44 supported directly above an associated cleaning component 40 and/or drying component 42 (e.g., an electric motor and nozzle, a fluid tank and a sprayer, fluid lines and a sprayer, electric wires and brushes, and/or the like). In some embodiments, the upper level structure 16 may be configured with hatch doors above the cleaning components 40 and the drying components 42 for providing access (e.g., even while the other components and the car wash facility 10 are still in service). The upper level structure 16 may also support cleaning equipment, such as cleaning components 40 and/or drying components 42 below the upper level support structure via hanging support from the upper level structure 16. Supportive components 44 may also be supported in hanging or depending manner below the upper level structure. Cleaning components 40 and drying components 32 are not explicitly shown in FIG. 5, but can be seen in FIG. 4 (with the upper level structure removed for clarity), and it will be appreciated that the upper level structure 16 can be overlaid over FIG. 4 to illustrate how the components 40/42 may be disposed below the upper level structure and supported in a hanging or depending manner.

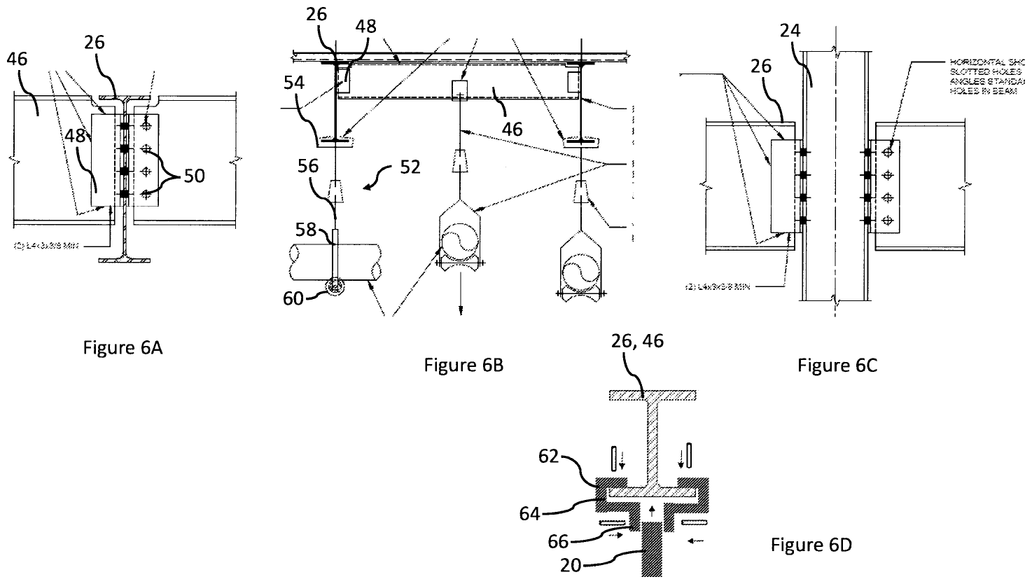

FIGS. 6A through 6D illustrate connections between various components and the upper level structure 16 to the frame structure 22. FIG. 6A illustrates a horizontal cross beam 46 (which extends longitudinally along the bay 12) connected between horizontal beams 26 (which extend laterally across the bay 12). In some embodiments, the upper level structure 16 is connected to the cross beam 46 and the cross beam 46 is connected to the at least two horizontal beams 26 via four L-shaped brackets 48 that are bolted through apertures 50. In some embodiments, the crossbeam 46 may be configured as an I-beam.

FIG. 6B illustrates a cross beam 46 connected between a pair of horizontal beams 26 and a hanging pipe and/or tube support 52 for pipes and/or tubes of the system. The pipe and/or tube support 52 includes a clamping bracket 54 and a hanging cable 56 extending from the clamping bracket 54 to a looped support end 58 that includes a roller 60 on a bottom portion thereof for feeding a pipe and/or tube therethrough. The roller 60 may include a circularly shaped depression that closely matches an outer diameter of the pipe and/or tube, which are showing in different orientations in FIG. 6B.

FIG. 6C illustrates the vertical columns 24 connected between horizontal beams 26 in accordance with another configuration. FIG. 6D illustrates a connection between the cables or hanging pillars 20 (which support the upper level structure 16) and the horizontal beams 26 and/or cross beams 46. In embodiments wherein the upper level structure 16 is configured as a mezzanine structure, a mezzanine support 62 may include at least one (e.g., a pair) of hook shaped members 64 that slide onto a top surface of the bottom flange of the I-beam of beams 26 and/or 46. Each hook shaped member 64 may include a vertical tail portion 66 that connects to the cables or hanging pillars 20 via additional bolts, clamps, and/or the like.

Thus, it is apparent from FIGS. 6A-6D that the beams 26 and 46 can be interconnected to define the upper portion of the frame structure 22, thereby providing a plurality of possible attachment locations for the both the upper level structure 16 as well as associated tubes and/or pipes extending both above and below the upper level structure within the bay 12, with examples of such pipes and/or tubes being illustrated through the figures.

FIG. 7 illustrates a cross-sectional, side view of the car wash facility 10. In some embodiments, mezzanine cross-supports 68 may be located along an undersurface of the upper level structure 16. In some embodiments, the cables or hanging pillars 20 may connected to the cross-supports 68 and the cross-supports 68 may cradle the upper level structure 16 and support its weight. FIG. 7 illustrates the upper level support 16 terminating short of the exit. As shown, the area adjacent the exit has a lower ceiling than the middle portion of the bay 12 and, accordingly, the upper level structure 16 does not extend into this lower ceiling area. Of course, it will be appreciated that different roof structures and ceiling arrangements may be used, and the upper level structure 16 within the bay may have various shapes to conform to the overall interior shape and space of the bay 12.

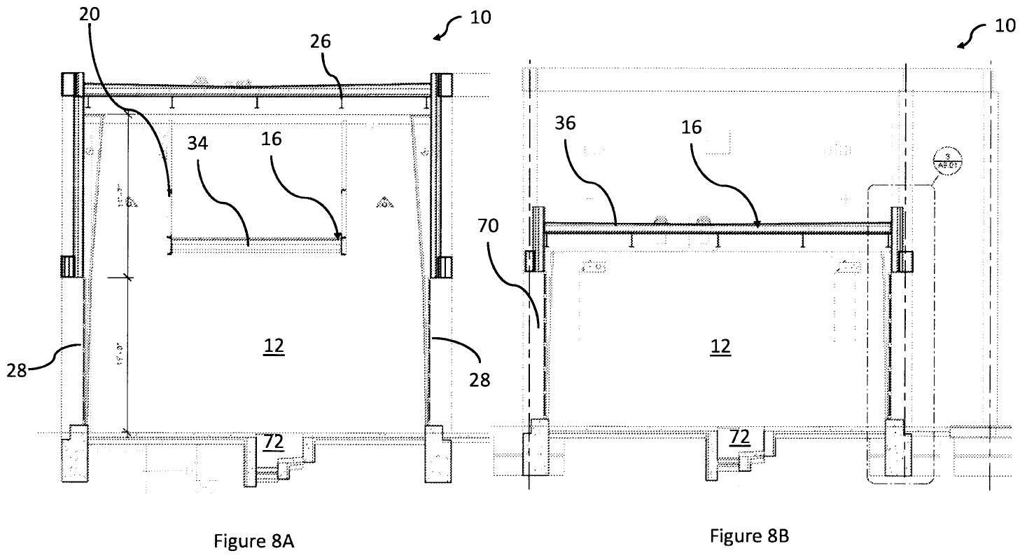

FIG. 8A illustrates an area adjacent the exit 32 of the bay 12 looking toward the entry and FIG. 8B illustrates an area adjacent the entry 30 of the bay 12 also looking toward the entry. In some embodiments, vertical column members 70 support the lateral section 36 shown in FIG. 8B, which is shown extending wider across the bay 12 relative to the longitudinal section 34 shown in FIG. 8A. A channel 72 is located below a floor of the bay 12 for capturing and routing fluids sprayed from various cleaning components 40.

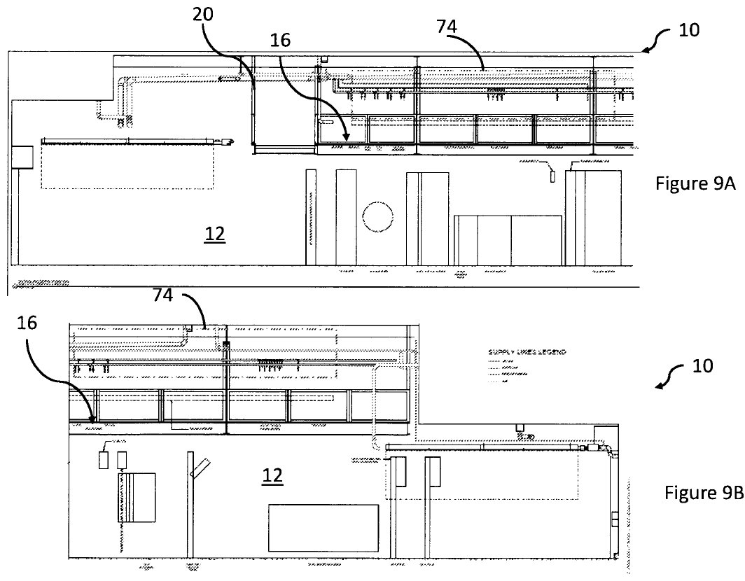

FIGS. 9A and 9B illustrate side views of the bay 12 showing a series of tubes and connectors 74 for associated cleaning components 40 and drying components 42 supported on or above the upper level structure 16. The series of tubes and connectors 74 may include a manifold of water tubes, exhaust tubes, additional tubes, and combinations thereof. In some embodiments, the tubes extend over a length of the upper level structure 16 and the connectors are located in spaced groupings over at least one of the cleaning components 40 and drying components 42 for connection thereto. FIG. 9B illustrates the exit end of the bay 12, and FIG. 9A illustrates the entry end.

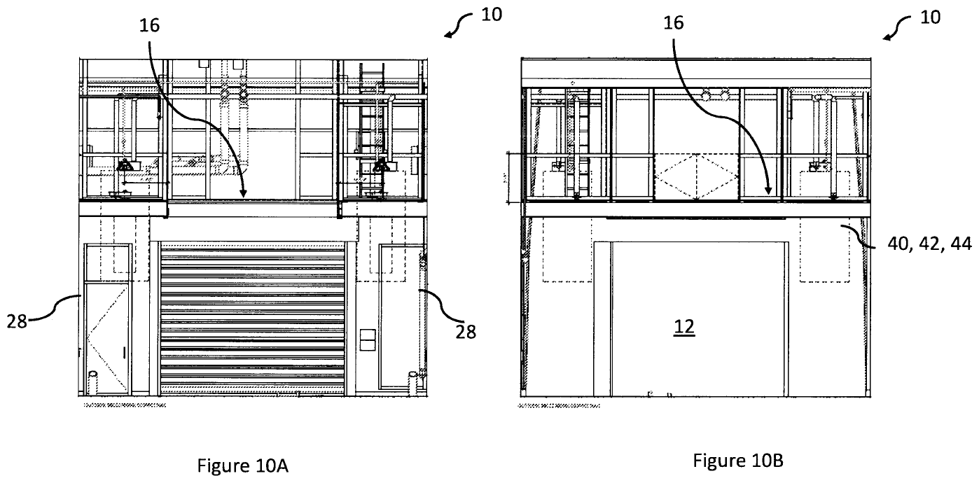

FIG. 10A illustrates the entry 30 of the bay 12 and FIG. 10B illustrates the exit of the bay 12 showing various components (40, 42, 44) supported on or above the upper level structure 16. In some embodiments, various components may be located in the space between the longitudinal section 34 and the sidewall 28, such that the various components may extend both above and below the upper level structure 16. The various components (40, 42, 44) may articulate vertically from a first position at least partially above the upper level structure 16 to a second, operable position that is lower than the first position. For example, the component may include a drying component 42 (e.g., a brush) that is located in the first (upper) position until a vehicle is located in a predetermined part of the bay 12 or car wash facility 10 whereat the brush may be articulated into the (lower) second, operable position.

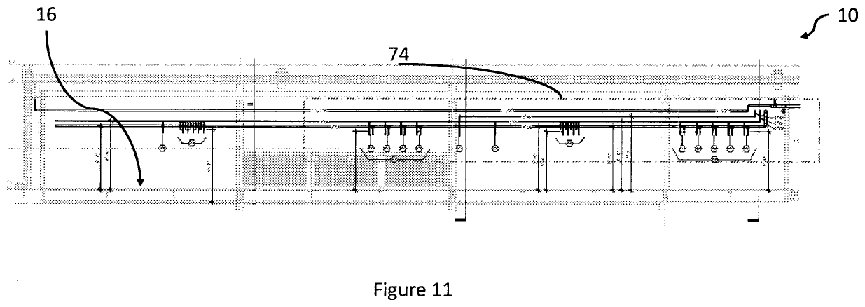

FIG. 11 illustrates additional connectors for associated cleaning components 40 and drying components 42 supported on or above the upper level structure 16. FIG. 11 is cut off and does not illustrate the area below the upper level structure, or the entry or exit. Put another way, FIG. 11 illustrates the area above the upper level structure 16. As illustrated, numerous hanging pipe and/or tube supports 52 (see FIG. 6B) may hang from the frame structure 22 to support the tubes extending along the area above the upper level structure 16 and provide fluid, electricity, and/or the like to one or more cleaning components 40 and drying components 42.

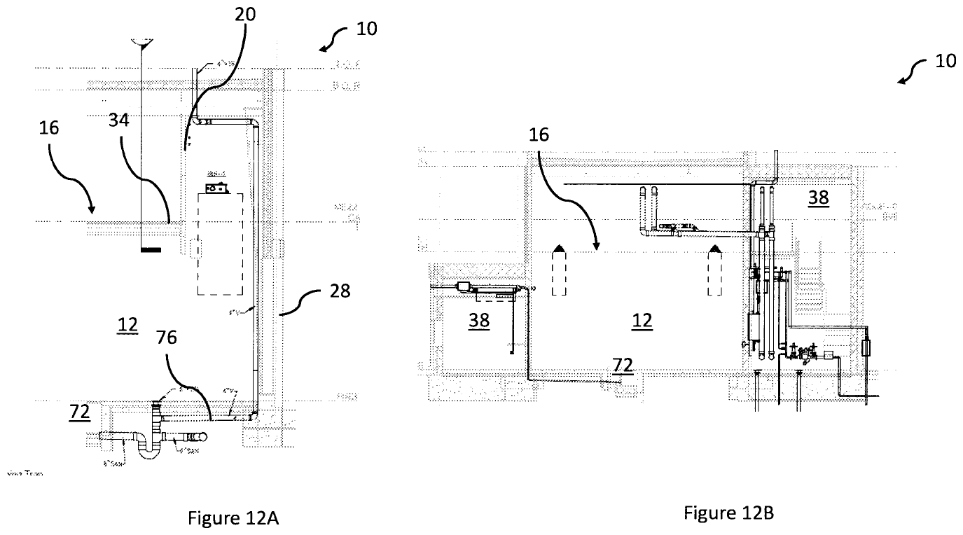

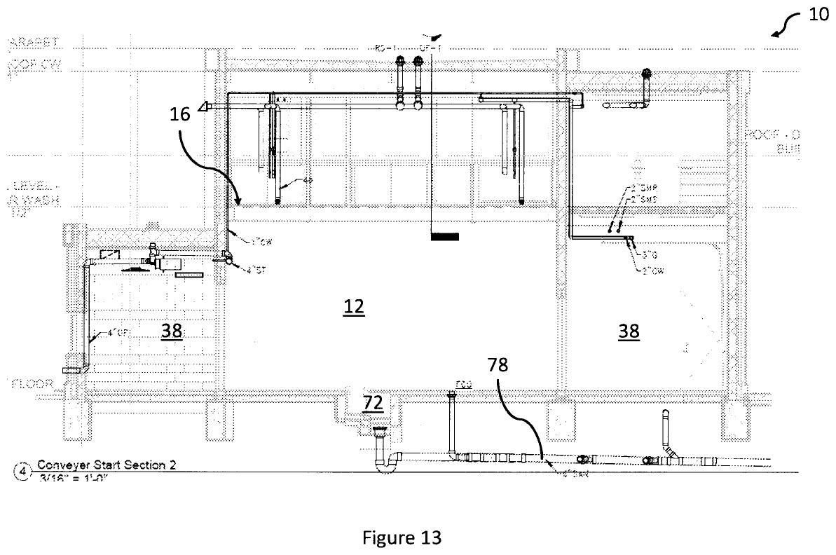

FIGS. 12A and 12B illustrate fluid inputs and outputs extending above and below the upper level structure 16. More particularly, FIG. 12A illustrates a recycling tube 76 extending from the channel 72 below the floor of the bay 12 to a location above the upper level structure 16. In some embodiments, the recycling tube 76 may extend from the channel 72 through a water-cleaning filter and into a water tank supported on or above the upper level structure 16, which may be located above a cleaning component 40. FIG. 12B illustrates a fluid control system for increasing or decreasing fluid flow to the vehicle wash facility 10. FIG. 13 illustrates additional fluid inputs and outputs extending above and below the upper level structure 16. In some embodiments, drainage pipes 78 may extend from the channel 72 to remove excess fluid from the vehicle wash facility 10.

In some embodiments, the upper level structure 16 may support and/or organize: overhead utilities from ceiling drop to configurations mounted thereon; stationary and localized configurations run therefrom to car wash equipment (e.g., washing and drying components) below; electric panels and connections to motors and lights; chemical delivery instruments and chemical storage; water lines to wash equipment and supporting configurations; air lines to wash equipment and supporting configurations; pneumatic controls; hanging signage and equipment from underside thereof; and heating elements and lighting fixtures supported thereon. The upper level structure 16 may further include pass-through channels for utilities that need to run across an underside of mezzanine. The upper level structure 16 may further provide visibility to wash operations below for observation on adjustments (see-through flooring). The upper level structure 16 “stacks” above the vehicle treatment area extending through the bay 12 to minimize footprint of overall vehicle wash facility 10, and also permits the use of optional garage doors on both sidewall areas of the bay 12 by removing “back room” items. Put another way, the use of the upper lever structure 16

In some embodiments, the car wash facility 10 may include a processor and a memory that contains instructions that cause the processor to, upon sensing a presence in a vehicle, lower a cleaning or drying component from a first position at least partially above the upper level structure to a second, operable position. The specific sensing mechanisms and mechanism for raising and lowering the device may vary and need not be described in detail herein. The spacing between the upper lever structure 16 and the sidewalls 28 of the bay 12 permits such selective vertical introduction of the vehicle wash components into the area adjacent the vehicle to be washed.

Note that not all of the activities described above in the general description or the examples are required, that a portion of a specific activity may not be required, and that one or more further activities may be performed in addition to those described. Still further, the orders in which activities are listed are not necessarily the order in which they are performed.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Many other embodiments may be apparent to those of skill in the art upon reviewing the disclosure. Other embodiments may be used and derived from the disclosure, such that a structural substitution, logical substitution, or another change may be made without departing from the scope of the disclosure. Accordingly, the disclosure is to be regarded as illustrative rather than restrictive.

Certain features are, for clarity, described herein in the context of separate embodiments, may also be provided in combination in a single embodiment. Conversely, various features that are, for brevity, described in the context of a single embodiment, may also be provided separately or in any sub combination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A vehicle wash facility comprising:
a bay extending between a pair of sidewalls and including at least one cleaning component adjacent a vehicle cleaning area; and
an upper level structure located above the bay and the vehicle cleaning area and supporting at least one supportive component above the at least one cleaning component, wherein the supportive component corresponds to the at least one cleaning component and is in the form of a fluid line, an electrical line, or an air line.

2. The vehicle wash facility of claim 1, wherein the upper level structure is configured as a mezzanine structure that hangs from a ceiling of the car wash facility.

3. The vehicle wash facility of claim 1, wherein the upper level structure is configured as a second floor that is at least partially formed of at least one of transparent or translucent material.

4. The vehicle wash facility of claim 1, wherein the upper level structure is at least partially in the form of a grate.

5. The vehicle wash facility of claim 4, wherein the upper level structure is at least partially formed of at least one of transparent or translucent material.

6. The vehicle wash facility of claim 5, wherein portions of the upper level structure formed of a grate are located above the at least one cleaning component.

7. The vehicle wash facility of claim 6, wherein portions of the upper level structure formed of a grate are moveable to an open position for access to the cleaning component.

8. The vehicle wash facility of claim 1, wherein the sidewalls extend longitudinally, wherein the upper level structure includes a longitudinal section extending at least partially along a longitudinal length of the bay, wherein the longitudinal section is laterally spaced away from the sidewalls.

9. The vehicle wash facility of claim 8, wherein at least one cleaning component is disposed in an open space that is laterally between the longitudinal section of the upper level structure and one of the sidewalls.

10. The vehicle wash facility of claim 9, wherein the cleaning component is moveable, within the open space, between an upper position and a lower position.

11. The vehicle wash facility of claim 1, wherein a plurality of cleaning components are disposed below the upper level structure, and a plurality of supportive components are disposed above the upper level structure.

12. The vehicle wash facility of claim 1, wherein the upper level structure is in the form of a mezzanine structure mounted above a floor of the bay.

13. The vehicle wash facility of claim 2, wherein the ceiling includes a frame structure having a plurality of interconnected laterally extending beams and longitudinally extending beams, wherein the upper level structure is supported by hanging pillars or cables extending downward from the frame structure.

14. The vehicle wash facility of claim 13, wherein the upper level structure includes a plurality of cross-supports extending below and cradling the upper level structure, wherein the cross-supports are attached to the hanging pillars.

15. The vehicle wash facility of claim 1, wherein the sidewalls are at least partially transparent or translucent along a lower section of a majority of the length of the bay to define a see-through section, wherein there are no rooms disposed laterally along the see-through section, wherein cleaning components are visible through the sidewalls along the see-through section, wherein the upper level structure defines an upper section for housing supporting components in a stacked manner to reduce the footprint of the vehicle wash facility.

16. A method of cleaning a vehicle at a vehicle wash facility, the method comprising:
receiving a vehicle within a vehicle wash bay defined by a pair of sidewalls and having a vehicle cleaning area, wherein the vehicle is received below an upper support structure disposed above the vehicle cleaning area;
activating a plurality of cleaning components adjacent the vehicle when the vehicle is in the vehicle cleaning area, wherein the cleaning components receive cleaning media from a plurality of supportive components associated with the cleaning components;
wherein the supportive components are supported above the upper level structure.

17. The method of claim 16, wherein the upper level structure includes a longitudinal section spaced away from the sidewalls within the vehicle wash bay, wherein at least some of the cleaning components are disposed in an open space between the sidewalls and the longitudinal section.

18. The method of claim 17, further comprising a vertically moveable cleaning component disposed in the open space, the vertically moveable cleaning component moveable from an upper position to a lower position adjacent the vehicle.

19. The method of claim 18, further comprising detecting the vehicle in the vehicle cleaning area and lowering the vertically moveable vehicle wash component in response.

20. The method of claim 16 further comprising accessing the cleaning component from above through the upper level structure.
